(19) United States
(12) Patent Application Publication
(10) Pub. No.: US 2011/0261355 A1
(43) Pub. Date: Oct. 27, 2011

(54) PORTABLE DEVICE AND METHOD FOR SPECTROSCOPIC ANALYSIS

(76) Inventors: Thaddaeus Hannel, Lexington, KY (US); Weston Johnson, Lexington, KY (US)

(21) Appl. No.: 13/092,067

(22) Filed: Apr. 21, 2011

Related U.S. Application Data
(60) Provisional application No. 61/326,690, filed on Apr. 22, 2010.

(51) Int. Cl. G01J 3/40; G01J 3/28

(52) U.S. Cl. 356/303; 356/326

(57) ABSTRACT

Spectroscopic devices and techniques for determining the presence or absence of an analyte of interest or the presence or absence of desired characteristics of an object are provided. In an embodiment, a portable device or attachment for a smart phone or comparable device includes a light source and a detector. The detector detects light after reflection from a target surface and, based upon attributes in the detected light absent from the emitted light such as covariances among different wavelengths, determines the presence or absence of the analyte of interest.

### CROSS-REFERENCE TO RELATED APPLICATIONS

This application claims priority to U.S. Provisional Application No. 61/326,690, filed Apr. 22, 2010, the disclosure of which is incorporated by reference in its entirety.

### BACKGROUND

Various spectroscopic techniques are known to determine properties of a sample, such as the presence or absence of a particular compound in the sample. Typically, these techniques involve analyzing light emitted, reflected, or transmitted by a material. Most such techniques require large, expensive equipment, and a relatively large amount of processing time and power.

Other analysis techniques are used to determine the properties or composition of a sample. For example, in the manufacture of pharmaceutical tablets, it is desirable to control such characteristics as the hardness and moisture content of drugs in tablet form. While tablets and other object can be tested for characteristics such as hardness and moisture content, conventional testing techniques typically are conducted only on a sample basis (as for example on a sample size equal to the square root of n+1 for n tablets). They also often involve substantial time and effort, and result in destruction of the tested samples.

Other analytic techniques require the collection of samples from surfaces to be analyzed, followed by extensive qualitative analysis of the samples. For example, in validating pharmaceutical cleaning processes, analysis has been done either by analyzing samples collected by swabbing a portion of the surface or by analyzing a rinse matrix collected after the surface has been cleaned. Such techniques may be inefficient. Swabbing techniques require manually swabbing the entire surface of interest to assure complete coverage, and necessitate time-consuming analysis of the swabs. Additionally, manual swabbing procedures are prone to incomplete analyte recovery from the surface or the swap. Total analysis time for the swabbing technique is extensive, resulting in lengthy downtimes for the pharmaceutical process equipment.

### BRIEF SUMMARY

The devices and methods disclosed herein relate to the field of analytical chemistry and, more particularly, to spectroscopic devices and techniques for determining the presence or absence of an analyte of interest or the presence or absence of desired characteristics of an object. Additional features, advantages, and embodiments of the invention may be set forth or apparent from consideration of the following detailed description, drawings and claims. Moreover, it is to be understood that both the foregoing summary of the invention and the following detailed description are exemplary and intended to provide further explanation without limiting the scope of the invention as claimed.

In an embodiment, a device includes a body having a connector configured to removably attach the device to a second device in the region of a light-detecting component of the second device, and a wide band light emitting source disposed on the body. The device may include at least one filter disposed adjacent to the wide band light emitting source, where the filter is configured to convert wide band light emitted by the wide band light emitting source to light having a plurality of wavelengths and substantially no covariance between light of different wavelengths. The device also may include executable instructions that cause the second device to identify a covariance in light emitted by the light emitting source and detected by the light-detecting component after reflecting from a target surface.

In an embodiment, a first device includes a body having a connector configured to removably attach the first device to a second device, where the second device includes a light-detecting component, and a light emitting source disposed on the body, the light emitting source configured to emit modulated light having a plurality of wavelengths.

In an embodiment, a method for analyzing a surface includes emitting light at a plurality of wavelengths toward an agricultural item such as produce, detecting light reflected from the agricultural item, and determining a relationship among different wavelengths in the detected light that was absent from the same wavelengths in the emitted light. Based upon the determined relationship an attribute of the agricultural item may be determined.

In an embodiment, a system includes a wide band light emitting source configured to emit modulated light having a plurality of different wavelengths toward a target surface to be tested for an analyte of interest, where the different modulations of the plurality of wavelengths are uncorrelated to the each of the other modulated wavelengths so as to substantially eliminate covariance between light of differing wavelengths, and a filter disposed between the wide band light emitting source and the target surface. The system may include a wide band light detector for detecting light scattered back from the target surface, and a processor configured to calculate a covariance of the detected light and, using said covariance, to determine the presence or absence of the analyte of interest.

In an embodiment, a method for analyzing a target surface includes obtaining discriminating spectral reflectance characteristics of an analyte of interest, emitting wide band light through a filter, to produce modulated light having a plurality of different wavelengths of collimated light, where the different modulations are uncorrelated to each of the other modulated wavelengths so as to substantially eliminate covariance between light of differing wavelengths. The method may include directing the modulated light having a plurality of wavelengths toward a target surface and detecting light scattered back from the surface. A signal may be generated to indicate whether the scattered light detected by the detector corresponds to a spectral reflectance characteristic of the analyte of interest.

### BRIEF DESCRIPTION OF THE DRAWINGS

The accompanying drawings, which are included to provide a further understanding of the invention, are incorporated in and constitute a part of this specification; illustrate embodiments of the invention and together with the detailed description serve to explain the principles of the invention. No attempt is made to show structural details of the invention in more detail than may be necessary for a fundamental understanding of the invention and various ways in which it may be practiced.

FIG. 1 shows an example of a device that includes a light emitting source directed to emit light toward a target surface.

FIG. 2 shows an example analysis based upon a database of RGB space values related to ripeness measures.

FIG. 3 shows an example device suitable for use with a smart phone or similar device.

FIG. 4 shows schematic side and end views of an example device incorporating a light source and a detector.

FIG. 5 shows a schematic view of an example embodiment that includes a sequence of tunable or non-tunable filters and one or more wide band light sources.

FIG. 6 shows an example circuit for subtracting detected ambient light values according to an embodiment.

FIG. 7 shows an example embodiment of a system configured to use transmission and/or absorption analysis.

FIG. 8 shows an example embodiment using multiple non-collimated light sources.

FIG. 9 shows a schematic of an example embodiment that includes multiple detectors to detect light reflected from an object.

FIG. 10 shows a schematic of an example embodiment that includes multiple surface to distribute light.

### DETAILED DESCRIPTION

Embodiments described herein may spectroscopically examine a target surface to determine the presence or absence of one or more particular analytes on the surface or other characteristic of the surface. If a particular analyte is present, the concentration level of the analyte and/or whether the analyte is present in acceptable limits may be determined. In general, a target surface of interest may be illuminated simultaneously with sequenced light pulses of different wavelengths at different locations from a light emitting array source. The wavelengths of light directed toward the target surface may be selected to correspond to absorbances or other characteristics of the analyte of interest. Light returned from the target surface may be collected and the light scatter in the returned light may be measured and used to determine whether the analyte of interest is present, and if so, the concentration of the analyte. As disclosed herein, various techniques may be used to generate the light directed and the surface, and to detect and analyze the returned light.

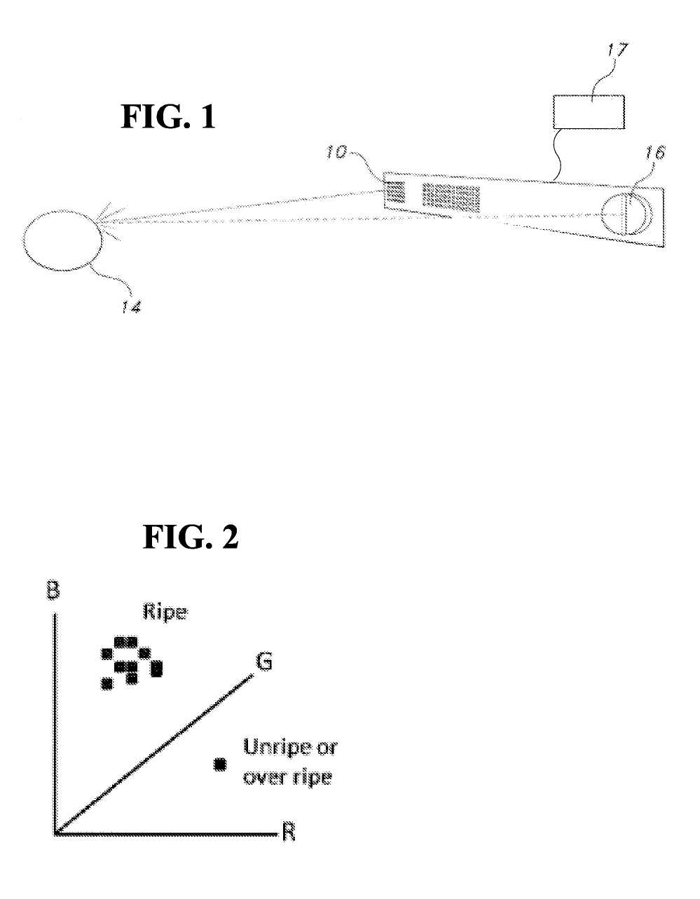

FIG. 1 shows an example embodiment of a device that includes a light emitting source 10, which is directed to emit light toward a target surface 14. In general, the target surface 14 can be any surface to be tested for the presence or absence of an analyte of interest. The light may be emitted at a plurality of wavelengths, and the different modulations of each emitter may be uncorrelated to each of the other wavelengths and/or aiming points. This may substantially eliminate covariance between light of different emitting elements. The amount of light per unit time also may be varied among the different wavelengths to facilitate quantification of the concentration of an analyte of interest.

A light detector 16, may be spaced from the emitting source by a distance sufficient to permit the light detector 16 to detect diffusely scattered light from the surface instead of specular reflectance. In the example embodiment illustrated, the light detector is shown as a single multicolor detector capable of detecting scattered light. The detector may be a wide band detector capable of detecting across a range of the electromagnetic spectrum. For example, the detector may detect within at least the ultraviolet, visible light and/or infrared ranges of the electromagnetic spectrum. A processor 17, which may include a computer-readable memory, may receive a signal from the light detector 16. The processor may perform various analytic processes using the received data to determine the composition or other attributes of the target surface. For example, the processor may calculate a covariance of the received scattered light, and compare the scattered light values received to spectral reflectance values stored in at least one table in the processor's memory. As described in further detail herein, various other analytics may be performed.

The light emitting source 10 may include an array, such as a rectangular array, of light emitting diodes, laser diodes, or other individual sources. As disclosed herein, many other types and arrangements of light emitting sources can also be used. The light emitting source may emit radiation with multiple wavelengths. In some embodiments, wavelengths may be selected for a particular application, and may be dependent upon the analyte on the target surface to be tested. For example, the wavelengths may be selected to correspond to the characteristic absorbencies of the analyte of interest. The diodes in a light emitting source also may have a predetermined spatial relationship. For example, vertical positions of diodes in a light emitting array may correspond to different vertical positions on a target surface 14. Each wavelength of light may be aimed at a plurality of different locations on the target surface of the article to be tested. The set of wavelengths may be independent of the set of aiming locations. Thus, for example, a set of light emitters, each with a unique pulse sequence, may be used to interrogate an article to be tested.

In an embodiment, each individual diode of the light emitting source 10 may be modulated to emit a pulse of light with a different orthogonal pulse sequence that substantially eliminates covariance with pulses from the remaining diodes. In such a configuration, the pulses may be configured such that there is a unique combination of pulses for any time interval. Such sequencing makes it possible to measure the total scattered light and to differentiate between the light scattered from the various modulations. With such sequencing, it is possible to detect and distinguish between scattered light from each of multiple diodes, for example with a single wide band light detector 16. More specifically, each of the different wavelengths may be modulated so that it is uncorrelated to the modulation of any other wavelength, and covariance between light at differing wavelengths is substantially eliminated. Other forms of modulation besides orthogonal pulse sequences may be used.

Light collected by the detector 16 may include light scattered from the interaction of the emitted light and the analyte on the surface of the target surface 14. Thus, unlike the zero covariance of the wavelengths emitted from the light emitting source 10, there may be covariance in the light detected by detector 16. Thus, a comparison between the waveforms of the emitted and received light may differ from a waveform that would result from merely summing the individual waveforms of the emitted light. Since the covariance between the light emitted from the individual diodes in the light source 10 is zero or substantially zero, the covariance between the pulse sequence applied to each diode and the light detected by the detector 16 is representative of the intensity of scattered light from the target surface at the position and wavelength specified by the diode with that modulation sequence.

In an embodiment, the covariance between the detected scattered light and the emitted light is proportional to the amount of scattered light, and is in turn proportional to the amount of the analyte on the target surface 14. This correlation may be used to determine the presence or absence of the analyte on the target surface, and, if the analyte is present, to further determine whether the amount of analyte is below acceptable limits.

As may be apparent to those skilled in the art, the techniques and devices disclosed herein may differ from approaches taken in traditional spectroscopic analysis. In traditional analysis, data are captured by a detector, and thereafter analyzed. In contrast, embodiments disclosed herein may use preexisting information about the spectral reflectance characteristics of an analyte or product, which may be empirically derived. The analyte or characteristic of interest may be recognized when the detected values of scattered light correspond to the values of the pre-existing derived information. In this way, a surface or product can be tested quickly to determine the location, identity and quantification of an expected analyte or characteristic. The pre-existing information may include spectral reflectance characteristics of the analyte or product, such as may be obtained through traditional spectrographic methods. Discriminating scattering and absorption bands of the analyte or product characteristic of interest, e.g., information about the position and strengths of absorption bands that are unique to the analyte or product of interest, may be used to identify and distinguish the analyte or characteristic of interest from other materials or conditions.

For example, wavelengths of collimated light that will produce scattered light within the discriminating scattering and absorption bands are selected to be emitted toward the target surface. Once the appropriate wavelengths are determined, the number of diodes, and the position of the diodes can be determined. The number and frequency of wavelengths needed may depend upon the analyte or characteristic of interest, and the modulations of the wavelengths may be selected so as to be uncorrelated to any other of the wavelengths in order to permit the single wide band light detector to differentiate between scattered light from different diodes. The light emitting source may be programmed to emit collimated light at the wavelengths chosen to identify and distinguish the analyte or characteristic of interest at modulations that are uncorrelated to each other.

In an embodiment the concentration of an analyte may be determined by mathematical analysis of the spectral reflectance information obtained from a surface. For example, a principal component analysis and least squares regression may be used to determine the fraction of each of a set of wavelengths sufficient to differentiate between different concentrates of the analyte. In such a configuration, the light emitting source can be coded to vary the amount of energy per unit time that is emitted at each wavelength. This variation in the amount of energy emitted can be achieved by either varying the intensity of emission, or by adjusting the duty cycle of the modulated signal. For example, the duty cycle of the pulse for selected frequencies may be modified to vary the amount of energy emitted per unit time. In some configurations, the number of frequencies emitted and amount of energy emitted per unit time may be selected to produce a light detector signal that varies linearly proportionally with analyte concentration. Thus, in some embodiment, wavelengths that discriminate the analyte or characteristic of interest from other expected analytes or characteristics may be selected, and the light emitting source modulated so as to substantially eliminate covariance and to emit disparate levels of light energy at different wavelengths, to determine the location, identity and concentration of an analyte of interest.

Additional information regarding the use of collimated light provided wavelength specific light emitting diodes as disclosed above, and additional devices and techniques suitable for use with those disclosed herein, is provided in U.S. Pat. No. 7,557,923 to Lodder, the disclosure of which is incorporated by reference in its entirety. Generally, the '923 patent describes systems and techniques that use a single wide band photodetector without intervening optics, and a processor to calculate covariances of scattered light received by the detector.

In an embodiment, a handheld spectroscopic instrument is provided for portable analysis of materials. Such a device may be suitable for applications in, for example, law enforcement, hazardous material handling and management, quality control inspection, homeland security, medicine, and pharmaceutical production and testing. Embodiments of the devices and techniques disclosed herein may permit nondestructive testing which may be useful, for example, when limited quantities of a material are involved or when legal issues involving evidentiary matters preferentially require materials to be preserved.

In an embodiment, a device may perform spectral emission of specific wavelengths as disclosed above, to enable the device to characterize a material. A light emitting source that emit light at predetermined wavelengths, such as one or more LEDs, may be configured to emit light as selected wavelengths based on the material to be characterized. The specific wavelengths may be selected based on empirically derived data for each material. The emitted light may be collimated via channels to a sample chamber in the device. The device may have at least one window into the sample chamber through which the collimated light enters, and through which reflections return to the device. In an embodiment, the device utilizes no optics such as lenses, filters, and the like.

In an embodiment, individual light emitting elements, such as individual LEDs, can be replaced individually or as groups on an interchangeable element. The specific response to each LED may be used to create a response spectrum which permits the device to characterize a material based upon comparison to known materials. Alternatively, lasers can be utilized as the light source to extend the effective range of the device, i.e., the distance over which a usable measurement may be made. The response can characterize chemical and physical characteristics of the material or object to be examined as previously disclosed.

Embodiments of the devices and techniques disclosed herein may be used in a variety of applications and configurations. For example, embodiments may be used in medical applications, such as the identification of certain skin and/or tissue traits. As a specific example, one application may be the identification of melanoma, which has a distinct light absorption pattern. Another example application is the identification of key biological markers to uniquely identify blood sugar. Other medical applications exist and are limited only by the collection of empirical data to determine useful wavelengths and the response to those wavelengths.

In an embodiment, a digital camera in communication with a data processor may use RGB components of a photo image to taken by the camera to make a material classification. One such example is the use of a camera associated with a smart phone, dedicated digital camera, or other similar device to characterize produce ripeness.

When assessing the ripeness of produce, fruit, or vegetables by eye, a consumer is in most cases making at best an educated guess as to whether or not the produce will be ripe. In most cases the consumer is dependent on the quality of their supermarket or on their own knowledge and observations for making a decision on the quality of produce. There are a number of devices that use both colorimetric and near infrared spectral analysis to assess the quality of fruit. However, these devices are not capable of being used by the laymen, suffer from high cost, and are not portable.

To improve the selection ability of produce embodiments of the disclosed subject matter may be used for noninvasive ripeness assessment. Some embodiments may use or be incorporated with an existing device, such as a smart phone.

In an embodiment, a smart phone equipped with a camera and flash, or equivalent device, may be used to capture an image of a produce item to be evaluated. An operator would select the type of fruit from a database and take a picture of the fruit. A software application on or accessible to the device may use RGB components of the photo image to make a classification of the produce item, such as to indicate the ripeness of the item. A library database may contain information on the region of the RGB space where ripe produce of the type being evaluated is most likely to be located. If the image data do not cluster within a certain range, for example, three standard deviations of the ripe cluster, the produce item is not considered to be ripe. An example illustration of such an analysis is shown in FIG. 2. It will be apparent to one of skill in the art that other specific RGB evaluation metrics may be used, and that the metrics may vary depending upon the species or type of produce being evaluated. In some embodiments, reference RGB data may be determined empirically and made available to the device as a library of ripeness values.

In an embodiment, a light source apparatus may be combined or integrated with a smart phone equipped with an imaging device such as a camera. The light source apparatus may include one or more of light sources that attach to the phone, such as by way of a removable clip. The light source may include multiple light sources that are configured to be disposed around the camera aperture of the smart phone, such that the camera photo array is disposed within the center of the individual light sources.

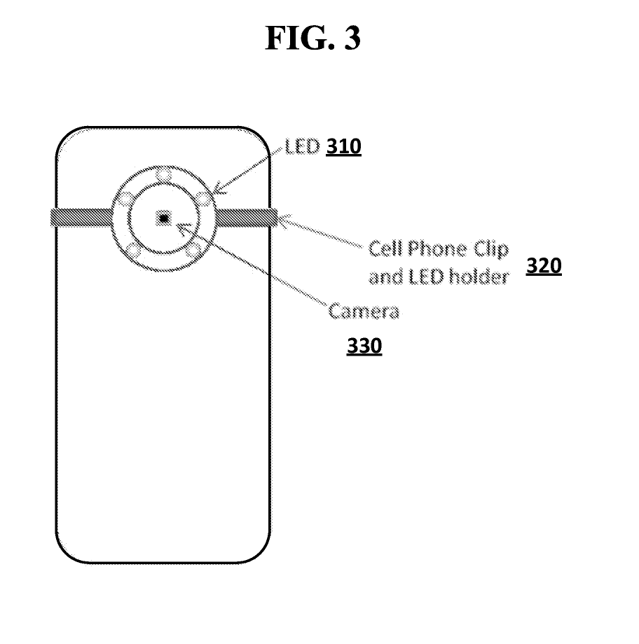

An example device according to an embodiment is shown in FIG. 3. As shown, the device may include a clip 320 or other mechanism to secure one or more LEDs 310 to the smart phone or other device. In the example, multiple LEDs are arranged around the camera 330 that is integral with the smart phone device. In the example device, the LED and mounting clip are removably attached to the smart phone, i.e., the LED arrangement may be removed from the smart phone by a user, and need not be permanently connected to the smart phone. Alternatively, a device may include one or more LEDs that are integral with the device.

As previously described, the light sources may be modulated, and the diffuse reflectance from a surface of interest may be detected by the camera. A database of spectral reflectance values and associated analysis software may be provided to the smart phone or other device, and used to classify the produce or other surface of interest.

In some configurations, devices and techniques as disclosed herein may make use of functionality available to components of a smart phone or other device that may not be used otherwise by the device. For example, many smart phone and other portable imaging devices have some sensitivity in the infrared and/or ultraviolet region of the spectrum. Any data obtained by the device in these regions are typically minimal compared to the visible spectrum, and are underutilized, as it is not visible to the human eye and thus not necessary when capturing images or video. In contrast, embodiments as disclosed herein may make use of this data, such as where the spectral reflectance values for an analyte of interest include discriminating values in these regions. As a specific example, certain types or species of produce may have discriminating spectral reflectance values in the infrared region when ripe. In this case, the device may use infrared data captured by the camera that normally would be discarded by the smart phone image processing software. As a specific example, near-infrared (NIR) light may be useful to identify or predict properties of agricultural samples, such as protein and water content in wheat, sugar content of fruits and vegetables, and the like. Thus, the use of NIR frequencies may allow for accurate measurement of produce or other agricultural items using a portable device as disclosed herein, such as a smart phone or a device usable or integrated with a smart phone or similar device.

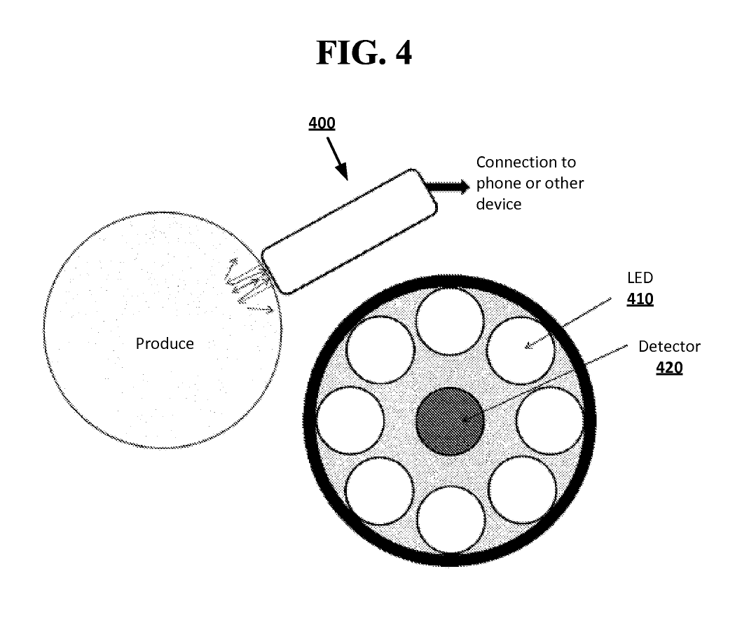

In an embodiment, a separate apparatus may be connected to a smart phone or other device. The device may be connected via a proprietary connection or a standardized connection, such as a Universal Serial Bus (USB) connection, a WiFi, Bluetooth, or other wireless connection, or any other suitable data connection. FIG. 4 shows schematic side and end view of an example device according to such an embodiment. The specific shape of the apparatus 400 may be selected for ease of arrangement of the internal components, but generally any shape or cross-sectional shape may be used. The apparatus may include one or more light emitting diodes 410 and a detector 420. This device connects to a smart phone or other computer for making diffuse reflectance measurements. The LEDs may be modulated and the diffuse reflectance is acquired by the detector as previously described. A library of known spectral reflectance values may be provided to the smart phone for use in classifying the produce or otherwise analyzing a surface or analyte of interest. Such configurations may allow a user to perform more complex analyses, using a combination of the dedicated light emitting source and dedicated detector, with the processing capability provided by the smart phone or similar device.

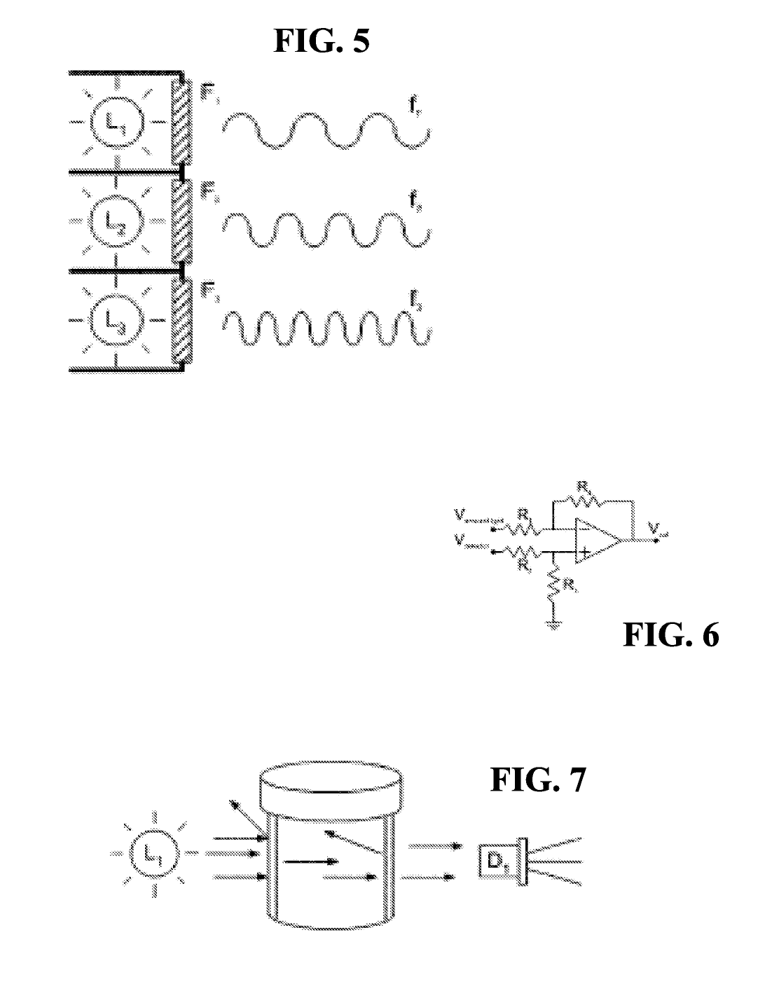

Although previously described in relation to narrowband light sources, some embodiments may make use of light sources that emit across a broad spectrum range, such as white LEDs or other wide band source. The wide band source may be filtered or otherwise modified to produce one or more desired wavelengths. In an embodiment, a sequence of tunable or non-tunable filters may be used to filter one or more wide band light sources to emulate and array of pulsing limited frequency light sources. An example embodiment of such a configuration is shown in FIG. 5. Rather than using light sources of a single frequency (or of substantially single frequency), the example makes use of one or more wide band light sources L1, L2, L3, whose emitted light must pass through one or more filters F1, F2, F3, before being directed at the target surface. This may allow for a reduced number of light sources as a range of frequencies f1, f2, f3, . . . and so on may be achieved by tuning the filter.

As a specific example, L1, L2 and L3 may be three separate and unique wide band light sources. Alternatively, the three sources could be replaced by a single source with multiple filters surrounding it.

While potentially adding to the complexity of the device, the use of optical filters may provide advantageous benefits that outweigh the added complexity. One advantage to using an optical filter may be that a single wide band light source can be used as a light source for all desired wavelengths. Thus, in a device, a single light source could be used with multiple filters or multiple light sources with multiple filters could be used. Regardless of the specific number of sources and filters used, the number of unique parts may be decreased relative to a configuration that uses an individual narrow-band light source for each desired wavelength, as many may be repeated. In some configurations, a wide band light source may be less expensive or require less source-specific hardware or software than would otherwise be the case for one or more light sources with a narrow frequency range.

The filter itself also may be able to dynamically modulate (tune) for a specific frequency or range of frequencies, such that the frequency range to be blocked or transmitted is adjustable through a hardware or software interface. For example, some LCD filters are able to achieve this within limited ranges. The number of components may be reduced when compared to configurations with fixed filters when a tunable filter is utilized. However, the costs and/or complexity involved with using a tunable filter may be relatively high, and may require additional environmental constraints (such as restrictions on operating temperature range).

The use of a wide band light source in conjunction with tunable or fixed filters may be desirable in situations where it is desired to use a single configuration to identify the presence and/or concentration of multiple, potentially-unrelated analytes of interest. As a specific example, the use of a wide band light source and appropriate filters may allow a device as disclosed herein to determine the presence and/or concentration of a first analyte interest that is known to have discriminating reflectance values in the visible region, and a second analyte of interest that has discriminating reflectance values in the ultraviolet region. As another example, the device may be used when it is desirable to have a relatively high number of frequencies for which pulses are sent, without the added complexity of a high number of LEDs or other light sources. The use of a wide band light source in conjunction with one or more filters also may be used in combination with the other embodiments and features described herein. Particularly, a filtered wide band light source may be particularly suited for use with devices that operate in conjunction with a smart phone or similar device. This may allow for greater flexibility for the combined device, while maintaining a relatively small physical size and portable form factor.

Thus, more generally, an embodiment of a system described herein may include a first device that has a body having a connector configured to removably attach the first device to a second device in the region of a light-detecting component of the second device, and a wide band light emitting source disposed on the body. The system may include at least one filter disposed adjacent to the wide band light emitting source that is configured to convert wide band light emitted by the wide band light emitting source to light having a plurality of wavelengths and substantially no covariance between light of different wavelengths. The system also may include a computer-readable medium storing instructions which, when provided to the second device, cause a processor in the second device to identify a covariance in light emitted by the light emitting source and detected by the light-detecting component after reflecting from a target surface. The filter may include a tunable filter or a non-tunable filter, and multiple filters may be used. Each filter may be removable from the device.

In another configuration, a system may include a first device having a body with a connector configured to removably attach the first device to a second device, where the second device includes a light-detecting component. The device also may include a light emitting source disposed on the body, configured to emit modulated light having a plurality of wavelengths. The light emitting source may be a wide band source or a narrow band source. The emitted light may have substantially no covariance between light of different wavelengths. The system also may include instructions that cause the second device to identify a covariance in light emitted by the light emitting source and detected by the light-detecting component after reflecting from a target surface. The second device may use data received from the light detecting component that would otherwise be unused by the second device, such as data related to light at wavelengths outside the visible spectrum. Generally, the light detecting component may include a digital camera, and the data that would otherwise be unused by the second device is information regarding light having a wavelength outside the visible spectrum. The system also may include a data connection configured to communicate with the second device. The system and/or the light emitting source may include a filter, such as a tunable filter, disposed adjacent to the wide band source. The second device may be, for example, a smart phone, a portable computer, or other similar device. The light emitting source may emit light in the ultraviolet, visible, and/or near infrared spectrum. The system may further include a database of spectral reflectance data for a plurality of analytes, which may include one or more types of produce.

As disclosed above, some embodiments may be used to assess produce or other agricultural items such as food items. Generally, such a technique may include emitting light at a plurality of wavelengths toward an agricultural item, detecting light reflected from the agricultural item, and determining a relationship among different wavelengths in the detected light, where the relationship is absent from the same wavelengths in the emitted light. Based upon the determined relationship, an attribute of the agricultural item, such as the ripeness, water content, or sugar content of the item may be determined. The attribute may be determined, for example, by comparing the relationship to a reference database of known reflectance values for a plurality of produce items. The emitted light may be generated by emitting wide band light through a filter, such as a tunable filter.

Various embodiments may include additional features, or may omit or have variations on any of the features described herein. In general, each embodiment may include the features and components of any other embodiment.

It may be desirable to use a relatively low-power light source for a portable device, to minimize energy usage and thereby prolong battery life. However, to maximize the signal-to-noise ratio, noise should be minimized while the light source intensity should be maximized.

The source of noise may occur from ambient light that penetrates the device to the detector, inherent noise within the detection circuitry, or from some environmental aberration during detection although other sources may exist.

In a device of high structural integrity such as one that has been entirely or almost entirely sealed to block light, it may be assumed that all background noise sources have been effectively blocked and thus do not contribute to the resulting signal on interest. However, typically a device structure is not entirely sealed. For example, a less-robust configuration may be used to minimize costs, correct for an environmental aberration, or in special applications, a structure of relatively lower integrity may be desirable. To increase the likelihood of obtaining meaningful results, the noise described above should be measured and eliminated or accounted for within the device or during processing. For example, after measuring noise, a signal of interest can be corrected to account for the measured noise using hardware, software or a combination thereof.

Ambient light is a type of noise that can degrade the performance of the device. For example, ambient light may result in a bias voltage or current at the detector. In an embodiment, ambient light or the effects of ambient light or other noise may be removed, counteracted, or otherwise accounted for during testing or analysis. As an example, a bias voltage or current may be removed or excluded from processing within the device. In an embodiment, software-based techniques may be used to account for ambient light or other noise. For example, the detector may be sampled when all light sources associated with the device are off, to obtain ambient light values. Such a technique may presume that an ambient light source has minimal variation during a pulse-and-detect sequence used to analyze a target surface for the presence and/or concentration of an analyte, as disclosed herein.

In some embodiments, various hardware techniques may be used to account for ambient light and other noise. For example, ambient light may be detected during a pulse-and-detect sequence. A differential amplifier or equivalent circuit may then be used to actively subtract a voltage value representing the ambient light from the voltage value of a pulse sequence. An example circuit suitable for subtracting the detected ambient light values is shown in FIG. 6. Other noise cancellation or accommodation techniques and circuits may be used and, in general, any detected type of noise may be accounted for in the same way as disclosed for ambient light.

Various embodiments may provide portable systems for non-in-situ uses. Embodiments of the subject matter disclosed herein may allow for relatively simple devices, allowing for fully-portable configurations. For example, micro-LEDs or other miniature light source may be used in conjunction with miniature and/or other micro sized power and control systems to reduce the size and weight of the system.

In an embodiment, light transmitted and/or absorbed by a surface may be detected instead of or in addition to light reflected from the surface. That is, devices and techniques disclosed herein may not be limited to spectral reflectance analysis. FIG. 7 shows an example embodiment of a system configured to use transmission and/or absorption analysis. The example system may include a light source L1, a container that is transparent to the at least some of the frequencies emitted by the light source, and specifically to those frequencies intended to be used for an analye of interest. An object to be analyzed, such as for the presence and/or concentration of an analyte, may be placed in the container. One or more detectors D1 may be used to detect light transmitted through and/or absorbed by the sample.

In general, the physical difference between a reflectance-based system and a transmission-based system is in the overall geometry. Both solids and liquids can be analyzed in either configuration or mode. A transmission or reflectance configuration may be selected, for example, based on the materials and application of interest. In configurations where a solid surface is to be imaged, reflectance-based systems may be more suitable. In a reflectance-based mode or configuration, light is scattered randomly from the surface of the analyte, and the amount of light scattered depends in part on the particle size of the analyte. For sufficiently small particle sizes the backscatter of radiation from the sample surface may be sufficiently high to prevent light from completely transmitting through the sample, resulting in a lower detected signal. In cases where radiation cannot be completely transmitted through the sample, a reflectance-based system may be more suitable, and in situations where the particle size of the sample is relatively large, a transmission-based configuration may be preferred. As will be apparent to one of skill in the art, other considerations such as sample thickness and wavelength may affect the selection of reflectance or transmission configurations. In an embodiment, a device may be capable of performing in either mode. For example, it may provide a user with a mechanism to select between a transmission-based configuration and a reflectance-based configuration.

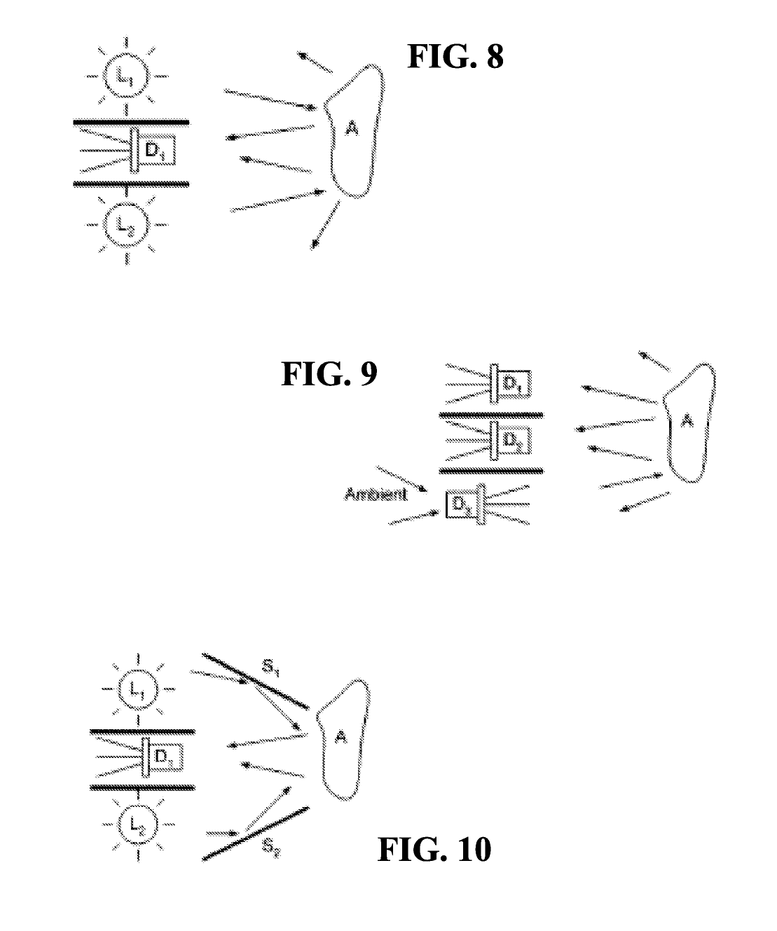

In an embodiment, a collimated light source may be used, such as described in U.S. Pat. No. 7,557,923. To help isolate and direct individual light sources a collimated and/or collimated path for the light is utilized. Alternatively, an embodiment may use a non-collimated light source. For example, if laser-based light sources or a variant pulse pattern is used, then a light guide such as a collimator may not be desired. In addition, certain analysis algorithms in software and/or hardware may be able to analyze the light structure in such a manner that a collimator is not necessary. FIG. 8 shows an example embodiment using multiple non-collimated light sources. The light sources L1, L2 emit non-collimated light, at least a portion of which is reflected from an object A and detected by the detector D1.

In an embodiment, a plurality of detectors may be used. The use of multiple detectors may provide improved integration, background light detection and reference, and improved absorption spectrums (UV, NIR, Visible etc.). In some configuration, software and/or hardware analysis algorithms may be used to eliminate the need for multiple detectors. However, in some configurations, multiple detectors may be desirable to improve performance of the system. FIG. 9 shows a schematic of an example embodiment in which multiple detectors D1, D2, D3 are used to detect light reflected from an object A to be analyzed for an analyte of interest. In some cases, a detector D3 may be used specifically to detect ambient light, thus allowing for other detector readings to be adjusted to account for ambient light levels as disclosed herein.

In an embodiment, more than one surface may be used for improved collection of scattered light. For example, in some applications it may be desirable to utilize multiple surfaces to improve collection of scattered light for improved analytical results. Increasing the collection of scattered light may increase the signal to noise ratio and/or allow for a reduced light intensity while still achieving equivalent results to a single surface system. FIG. 10 shows a schematic of an example embodiment in which multiple surface S1, S2 are used to improve distribution and/or collection of light emitted by light sources L1, L2 and reflected from an object A before being detected by the detector D1. The use of multiple surfaces as shown in FIG. 10 may, for example, homogenize light emitted by different sources. The effect may be likened to the use of an integrating sphere to obtain homogenous light on a surface.

In an embodiment, one or more polarized light sources and/or detectors may be used. Utilizing polarized light may allow for improved throughput of the system.

In an embodiment, an analog converter may be used for analysis and process, such as a nondiscrete time processor. In some configurations, analog converters and/or hardware-mimicking processors such as FPGAs also may allow for improved processing times.

Embodiments of the techniques and devices used herein may be used for transmission analysis to identify and/or quantify the presence of specific analytes in liquid. For example, one application may be the identification of drugs in urine. Other applications may include, for example, applications of cleaning validation in food processing (including but not limited to dairy, meat, produce), and industrial applications such as petrochemical, pulp and paper.

In some configurations, embodiments may be used for quality control purposes, such as in the manufacture of chemical products, such as petrochemicals and the like. The system can be utilized to determine the presence of specific additive systems in lubricants or fuels and can also be used to test for the presence of common contaminants, such as water.

In an embodiment, a system as disclosed herein may be encapsulated in shielding to isolate the electronics from electro-magnetic interference is an additional embodiment. Removing stray light and electromagnetic noise from the system may provide for improved sampling and analysis. Similarly, shielding to reduce outside noise may provide additional benefit.

The systems and techniques described herein may be implemented on or by any combination of local and remote, or server and client devices. For example, in some configurations the light emission and reflected light detection may be performed by a local device, and the analysis of the detect light, such as to determine covariances in the light, may be performed by a local processor or a remote processor in communication with the local device. Similarly, the local processor may be integral with the light emitting source and/or the detector, or may be physically separate from, but in communication with, the source and/or the detector.

The foregoing descriptions of the exemplary embodiments of the invention have been presented for purposes of illustration and description only. They are not intended to be exhaustive or to limit the invention to the precise forms disclosed, and modifications and variations are possible and contemplated in light of the above teachings. While a number of exemplary and alternate embodiments, methods, systems, configurations, and potential applications have been described, it should be understood that many variations and alternatives could be utilized without departing from the scope of the invention. It should be reiterated that not all aspects of the invention need to be used in combination with all other aspects, and a variety of combinations of such aspects are possible. Thus, it should be understood that the embodiments and examples have been chosen and described in order to best illustrate the principals of the invention and its practical applications to thereby enable one of ordinary skill in the art to best utilize the invention in various embodiments and with various modifications as are suited for particular uses contemplated. Accordingly, it is intended that the scope of the invention be defined by the claims appended hereto.

Various embodiments may include or be embodied in the form of computer-implemented processes and apparatuses for practicing those processes. Embodiments also may be embodied in the form of a computer program product having computer program code containing instructions embodied in tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing the invention. Embodiments also may be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing the invention. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Embodiments may be implemented using hardware that may include a processor, such as a general purpose microprocessor and/or an Application Specific Integrated Circuit (ASIC) that embodies all or part of the method in accordance with the present invention in hardware and/or firmware. The processor may be coupled to memory, such as RAM, ROM, flash memory, a hard disk or any other device capable of storing electronic information. The memory may store instructions adapted to be executed by the processor to perform the method in accordance with an embodiment of the present invention.

1. A system comprising:
a first device comprising:
a body comprising a connector configured to removably attach the first device to a second device in the region of a light-detecting component of the second device; and
a wide band light emitting source disposed on the body;
at least one filter disposed adjacent to the wide band light emitting source, and configured to convert wide band light emitted by the wide band light emitting source to light having a plurality of wavelengths and substantially no covariance between light of different wavelengths;
a computer-readable medium storing instructions which, when provided to the second device, cause a processor in the second device to identify a covariance in light emitted by the light emitting source and detected by the light-detecting component after reflecting from a target surface.

2. A system as recited in claim 1, wherein the at least one filter comprises a tunable filter.

3. A system as recited in claim 1, wherein the at least one filter comprises a plurality of filters, each of which is removable from the first device.

4. A system comprising:
a first device comprising:
a body comprising a connector configured to removably attach the first device to a second device, the second device comprising a light-detecting component; and
a light emitting source disposed on the body, the light emitting source configured to emit modulated light having a plurality of wavelengths.

5. A system as recited in claim 4, wherein the emitted light has substantially no covariance between light of different wavelengths.

6. A system as recited in claim 4, further comprising:
a computer-readable medium storing instructions which, when provided to the second device, cause a processor in the second device to identify a covariance in light emitted by the light emitting source and detected by the light-detecting component after reflecting from a target surface.

7. A system as recited in claim 6, said instruction further causing the processor to use data received from the light detecting component that would otherwise be unused by the second device.

8. A system as recited in claim 7, wherein the light detecting component is a digital camera, and the data that would otherwise be unused by the second device is information regarding light having a wavelength outside the visible spectrum.

9. A system as recited in claim 4, said first device further comprising a data connection configured to communicate with the second device.

10. A system as recited in claim 4, said light emitting source comprising a wide band source.

11. A system as recited in claim 10, said light emitting source further comprising a filter disposed adjacent to the wide band source.

12. A system as recited in claim 11, said filter comprising a tunable filter.

13. A system as recited in claim 4, wherein said second device is a smart phone.

14. A system as recited in claim 4, said light emitting source being configured to emit light in the ultraviolet, visible, near infrared, or a combination thereof of the electromagnetic spectrum.

15. A system as recited in claim 4, further comprising a database of spectral reflectance data for a plurality of analytes.

16. A system as recited in claim 15, said database storing spectral reflectance data for produce.

17. A system as recited in claim 4, wherein the light detecting component is a digital camera.

18. A method comprising:
emitting light at a plurality of wavelengths toward an agricultural item;
detecting light reflected from the agricultural item;
determining a relationship among different wavelengths in the detected light, the relationship being absent from the same wavelengths in the emitted light;
based upon the determined relationship, determining an attribute of the agricultural item.

19. A method as recited in claim 18, wherein the agricultural item is an item of produce, and the determined attribute is the ripeness of the item.

20. A method as recited in claim 18, wherein the attribute is determined by comparing the relationship to a reference database of known reflectance values for a plurality of produce items.

21. A method as recited in claim 18, wherein the step of emitting light at plurality of wavelengths comprises emitting wide band light through a filter.

22. A method as recited in claim 21, wherein the filter is a tunable filter.

23. A system comprising:
a wide band light emitting source configured to emit modulated light having a plurality of different wavelengths toward a target surface to be tested for an analyte of interest, the different modulations of the plurality of wavelengths being uncorrelated to the each of the other modulated wavelengths so as to substantially eliminate covariance between light of differing wavelengths;
a filter disposed between the wide band light emitting source and the target surface;
a wide band light detector for detecting light scattered back from the target surface; and
a processor configured to calculate a covariance of the detected light and, using said covariance, to determine the presence or absence of the analyte of interest.

24. A method comprising:
obtaining discriminating spectral reflectance characteristics of an analyte of interest;
emitting wide band light through at least a first filter, to produce modulated light having a plurality of different wavelengths of collimated light, where different modulations of the plurality of wavelengths are uncorrelated to each of the other modulated wavelengths so as to substantially eliminate covariance between light of differing wavelengths;
directing the modulated light having a plurality of wavelengths toward a target surface;
detecting light scattered back from the surface; and
generating a signal when the scattered light detected by the detector corresponds to a spectral reflectance characteristic of the analyte of interest.
